(19) United States
(12) Patent Application Publication
(10) Pub. No.: US 2013/0139355 A1
(43) Pub. Date: Jun. 6, 2013

(54) HINGE MECHANISM AND FOLDABLE ELECTRONIC DEVICE

(71) Applicants: Jui-Yuan Lee, Taipei City (TW); Hui-Lian Chang, Taipei City (TW); Ming-Wang Lin, Taipei City (TW); Chih-Chiang Wang, Taipei City (TW); Hsin-Hsiang Shao, Taipei City (TW); Chun-Wei Chang, Taipei City (TW)

(72) Inventors: Jui-Yuan Lee, Taipei City (TW); Hui-Lian Chang, Taipei City (TW); Ming-Wang Lin, Taipei City (TW); Chih-Chiang Wang, Taipei City (TW); Hsin-Hsiang Shao, Taipei City (TW); Chun-Wei Chang, Taipei City (TW)

(73) Assignee: COMPAL ELECTRONICS, INC., Taipei City (TW)

(21) Appl. No.: 13/587,926

(22) Filed: Aug. 17, 2012

Related U.S. Application Data
(60) Provisional application No. 61/567,128, filed on Dec. 6, 2011.

(51) Int. Cl. E05D 7/00; E05D 3/06

(52) U.S. Cl. 16/354

(57) ABSTRACT

A hinge mechanism suitable for a foldable electronic device has a first body, a second body and a hinging-body. The hinge mechanism includes a first cradle, a second cradle, a pair of pivoting-shafts, a pair of position-limiting elements, a set of gears and a positioning element. The positioning-element is fixed to the hinging-body and structurally independent from the position-limiting elements, pivoted to the pivoting-shafts so as to be detachably assembled with the position-limiting elements. The first body rotates relatively to the hinging-body through the first cradle rotates the pivoting-shaft fixed to the first cradle relatively to the positioning element so as to rotate the set of gears, make the second cradle rotate the pivoting-shaft fixed to the second cradle relatively to the positioning-element and bring the second body for rotation relatively to the hinging-body. Additionally, a foldable electronic device is also provided.

### CROSS-REFERENCE TO RELATED APPLICATION

This application claims the priority benefit of U.S. provisional application serial. No. 61/567,128, filed Dec. 6, 2011. The entirety of the above-mentioned patent application is hereby incorporated by reference herein and made a part of this specification.

### BACKGROUND OF THE INVENTION

1. Field of the Invention

The invention generally relates to an electronic device and a hinge mechanism thereof, and more particularly, to a foldable electronic device and a hinge mechanism thereof.

2. Description of Related Art

In the information age today, people have increasing dependence on the electronic devices. In response to the high-speed, high-performance and thin-oriented requirements of the electronic products nowadays, the foldable electronic device such as notebook computer has become mainstream and has become an indispensable tool in modern life. In general, the foldable electronic device uses the folding way to reduce the placing-back area so as to achieve a light-slim-short-small design goal for electronic products.

A notebook computer mainly includes a display and a host body, in which the display and the host body usually are mutually connected through a hinge mechanism. In this way, when a user opens or closes the foldable electronic device, the display and the host body would relatively rotate through the hinge mechanism.

ROC Patent Bulletin No. TWM391012 revealed a hinge structure suitable for foldable electronic devices to rotate a display and a host body mutually pivoted to each other. the hinge structure includes a first rotation module (10), a second rotation module (30), a set of secondary gears (50), a first position-limiting element (70) and a second position-limiting element (90), where the first position-limiting element (70) includes a position-limiting portion (71) and a connection portion (73) which are integrally formed. In the above-mentioned patent, when the position-limiting portion (71) and the second position-limiting element (90) together clamp the set of secondary gears (50), the connection portion (73) would cross at least a primary gear module (12), the second position-limiting element (90), friction disks (14), a set of springs (15), flat washers (16), fasteners (17) and a set of secondary gears (50). Therefore, the overall thickness of the hinge structure will be increased.

In addition, ROC Patent Bulletin No TWM396575 also discloses a hinge structure which includes a first shaft assembly (10), a second axis shaft assembly (30), a transmission assembly (50), a connector (70) and a holding piece (90), in which the holding piece (90) includes a sleeve joining portion (91) and a bending portion (93) which are integrally formed. In the above-mentioned patent, when the sleeve joining portion (91) and connector (70) together clamp the transmission assembly (50), the sleeve joining portion (91) would cross at least primary gears (15), the connector (70), and the transmission assembly (50). Therefore, the overall thickness of the hinge structure will be increased. However, the specification of the current foldable electronic device continually gets lighter, thinner, shorter and smaller so that the space of disposing the hinge mechanism is accordingly limited, which strongly requires to reduce the thickness of the hinge mechanism.

### SUMMARY OF THE INVENTION

Accordingly, the invention is directed to a hinge mechanism with reduced thickness.

The invention is also directed to a foldable electronic device with a thinner hinge mechanism.

The invention provides a hinge mechanism suitable for a foldable electronic device, in which the foldable electronic device has a first body, a second body and a hinging-body. The hinge mechanism includes a first cradle, a second cradle, a pair of pivoting-shafts, a pair of position-limiting elements and a set of gears. The first cradle is configured to be fixed to the first body. The second cradle is configured to be fixed to the second body. The pair of pivoting-shafts is respectively fixed to the first cradle and the second cradle. The set of gears has a pair of primary gears and a pair of secondary gears, in which the pair of primary gears is located between the pair of position-limiting elements, the pair of pivoting-shafts goes through the pair of position-limiting elements and respectively goes through the pair of primary gears to pivot the pair of primary gears between the pair of position-limiting elements, the pair of secondary gears is located between the pair of position-limiting elements and pivoted to the pair of position-limiting elements, the pair of primary gears is respectively engaged with the pair of secondary gears, and the pair of secondary gears is engaged with each other. The positioning-element is configured to be fixed to the hinging-body and structurally independent from the pair of position-limiting elements, in which the positioning-element is pivoted to the pair of pivoting-shafts to be detachably assembled with the pair of position-limiting elements. The first body rotates relatively to the hinging-body through the first cradle rotates the pivoting-shaft fixed to the first cradle relatively to the positioning element so as to bring both the pair of primary gears and the pair of secondary gears for rotation, to make the second cradle rotate the pivoting-shaft fixed to the second cradle relatively to the positioning-element and to bring the second body for rotation relatively to the hinging-body.

The invention also provides a foldable electronic device, which includes a first body, a second body, a hinging-body, a hinge mechanism. The hinge mechanism includes a first cradle, a second cradle, a pair of pivoting-shafts, a pair of position-limiting elements, a set of gears and a positioning-element. The first cradle is fixed to the first body. The second cradle is fixed to the second body. The pair of pivoting-shafts is respectively fixed to the first cradle and the second cradle. The set of gears has a pair of primary gears and a pair of secondary gears, in which the pair of primary gears is located between the pair of position-limiting elements, the pair of pivoting-shafts goes through the pair of position-limiting elements and respectively goes through the pair of primary gears to pivot the pair of primary gears between the pair of position-limiting elements, the pair of secondary gears is located between the pair of position-limiting elements and pivoted to the pair of position-limiting elements, the pair of primary gears is respectively engaged with the pair of secondary gears, and the pair of secondary gears is engaged with each other. The positioning-element is fixed to the hinging-body and structurally independent from the pair of position-limiting elements, in which the positioning-element is pivoted to the pair of pivoting-shafts so as to be detachably assembled with the pair of position-limiting elements. The first body rotates relatively to the hinging-body through the first cradle rotates the pivoting-shaft fixed to the first cradle relatively to the positioning element so as to bring both the pair of primary gears and the pair of secondary gears for rotation, to make the second cradle rotate the pivoting-shaft fixed to the second cradle relatively to the positioning-element and to bring the second body for rotation relatively to the hinging-body.

Based on the description above, the positioning-element of the invention is structurally independent from the pair of position-limiting elements, i.e., the positioning element and the position-limiting elements are not integrally formed. In comparison with the prior art where the positioning element and the position-limiting elements are integrally formed, the invention does not need the conventional layout of crossing the set of gears and other parts. As a result, the overall thickness of the hinge mechanism is reduced. Therefore, in the invention, the positioning element and the position-limiting elements are individually disposed at the hinge mechanism so as to reduce the overall thickness of the hinge mechanism, and the thickness of the hinge mechanism of the foldable electronic device is reduced as well.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIGS. 1A and 1B are schematic diagrams respectively showing the closing state and an open state of a foldable electronic device according to an embodiment of the invention.

FIG. 2 is a three-dimensional diagram of the hinge mechanism of the foldable electronic device in FIG. 1B.

FIG. 3 is an exploded diagram of the hinge mechanism of the foldable electronic device in FIG. 1B.

### DESCRIPTION OF THE EMBODIMENTS

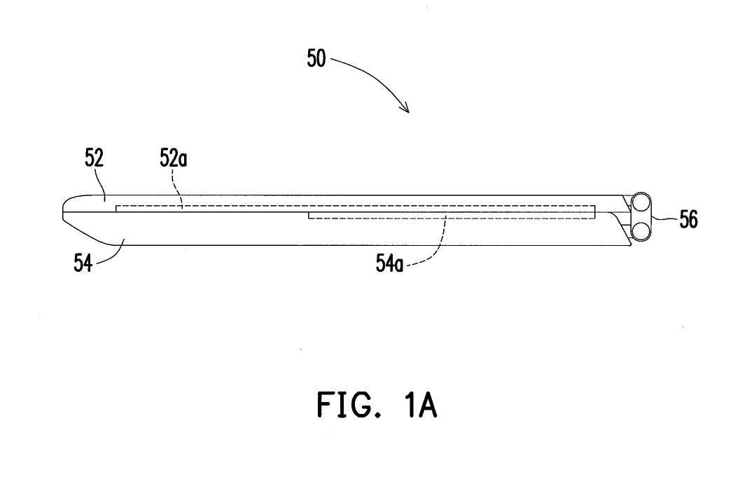

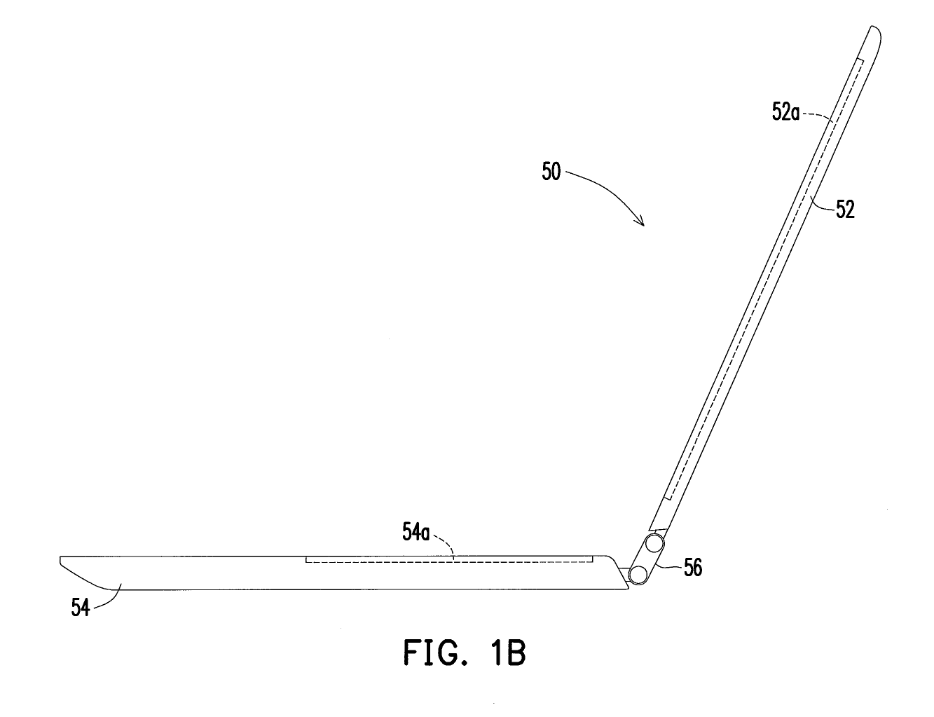

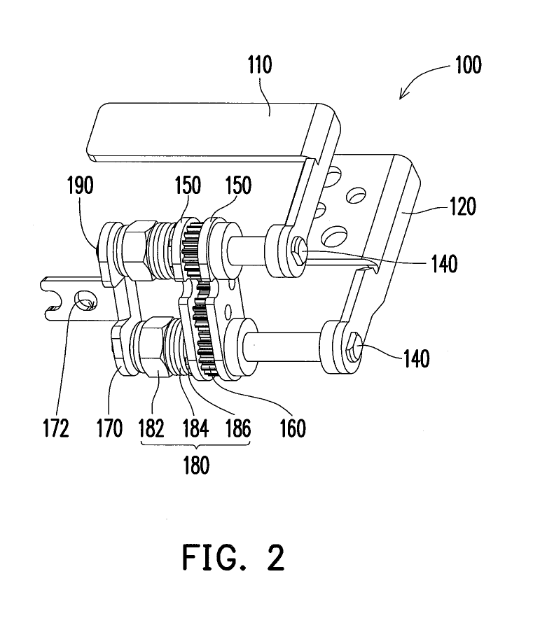

FIGS. 1A and 1B are schematic diagrams respectively showing the closing state and an open state of a foldable electronic device according to an embodiment of the invention. Referring to FIGS. 1A and 1B, in the embodiment, the foldable electronic device 50 includes a first body 52, a second body 54, a hinging-body 56 and a hinge mechanism 100 (Referring to FIG. 2).

In the embodiment, the hinge mechanism 100 makes the first body 52 rotate relatively to the hinging-body 56. Meanwhile, the second body 54 also rotates relatively to the hinging-body 56 so as to open or close the foldable electronic device 50. The foldable electronic device 50 is, for example, a notebook computer combining a display module (the first body 52) and an input module (the second body 54). The first body 52 can include a display screen 52a and the second body 54 can include a keyboard 54a so that a user can operate the foldable electronic device 50 through the keyboard 54a and watch the frame displayed by the display screen 52a.

In the invention, the hinge mechanism 100 can be opened/closed in a double speed than the regular speed and the thickness of the hinge mechanism 100 is reduced so as to make the hinge mechanism of the foldable electronic device 50 thinner, referring the following examples with figures.

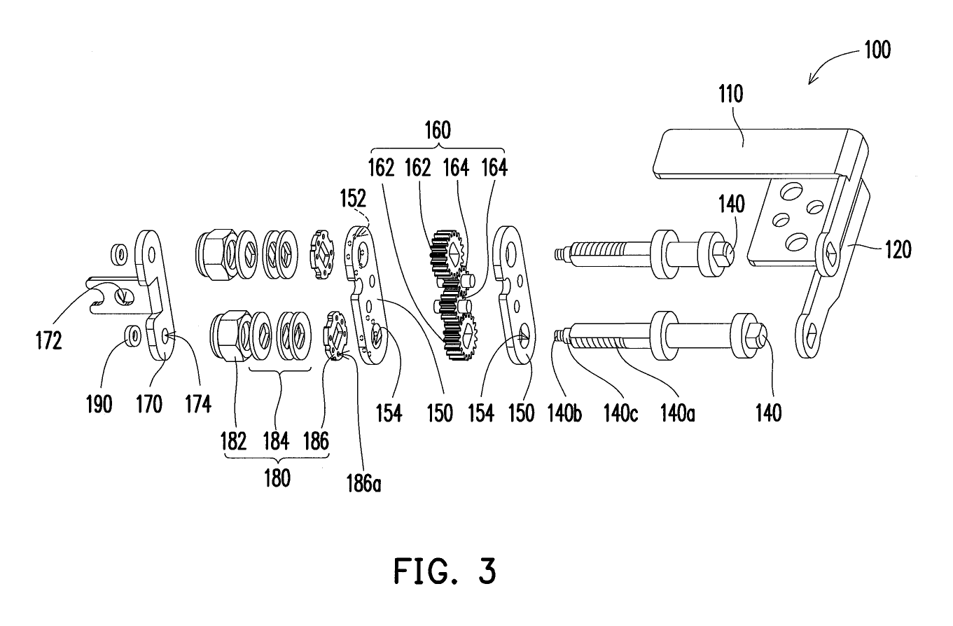

FIG. 2 is a three-dimensional diagram of the hinge mechanism of the foldable electronic device in FIG. 1B and FIG. 3 is an exploded diagram of the hinge mechanism of the foldable electronic device in FIG. 1B. Referring to FIGS. 1A, 1B, 2 and 3, in the embodiment, the hinge mechanism 100 includes a first cradle 110, a second cradle 120, a pair of pivoting-shafts 140, a pair of position-limiting elements 150, a set of gears 160 and a positioning-element 170. The first cradle 110 is fixed to the first body 52. The second cradle 120 is fixed to the second body 54. The pair of pivoting-shafts 140 of the embodiment is respectively fixed to the first cradle 110 and the second cradle 120.

Specifically, the set of gears 160 has a pair of primary gears 162 and a pair of secondary gears 164 and the pair of primary gears 162 is located between the pair of position-limiting elements 150. The pair of pivoting-shafts 140 respectively goes through the pair of position-limiting elements 150 and respectively goes through the pair of primary gears 162 to pivot the primary gears 162 between the two position-limiting elements 150. The pair of secondary gears 164 is located between the pair of position-limiting elements 150 and pivoted to the two position-limiting elements 150. The pair of primary gears 162 and the secondary gears 164 are engaged with each other and the two secondary gears 164 are selves engaged with each other.

The positioning-element 170 in the embodiment is fixed to the hinging-body 56 and pivoted to the pair of pivoting-shafts 140. However, the invention does not limit the way of fixing the positioning-element 170 to the hinging-body 56. For example, the positioning-element 170 has an assembling hole 172 and the hinging-body 56 has a corresponding fastener (for example, a screw), where the fastener goes through and is fixed to the assembling hole 172 to fix the hinge mechanism 100 at the hinging-body 56.

On the other hand, the positioning-element 170 is pivoted to the pair of pivoting-shafts 140 to be detachably assembled with the pair of position-limiting elements 150. In more details, the positioning-element 170 and the position-limiting elements 150 in the embodiment are structurally independent, i.e., the positioning-element 170 and the position-limiting elements 150 are not integrally formed but independently formed, which does not need the conventional layout of crossing the set of gears 160 and other parts, so as to reduce the overall thickness of the hinge mechanism 100. Therefore, the embodiment makes the positioning-element 170 and the position-limiting elements 150 individually disposed at the hinge mechanism 100 to reduce the thickness of the hinge mechanism 100 and accordingly the thickness of the hinge mechanism of the foldable electronic device 50.

Under the above-mentioned layout, the first body 52 rotates relatively to the hinging-body 56 through the first cradle 110 rotates the pivoting-shaft 140 fixed to the first cradle 110 relatively to the positioning element 170, so as to bring both the pair of primary gears 162 and the pair of secondary gears 164 for rotation. Thereby, the second cradle 120 rotates the pivoting-shaft 140 fixed to the second cradle 120 relatively to the positioning-element 170, so as to bring the second body 54 for rotation relatively to the hinging-body 56. Therefore, through the design of the embodiment of disposing a pair of pivoting-shafts at the hinge mechanism 100, the hinge mechanism 100 brings the first body 52 rotates relatively to the hinging-body 56, also brings the second body 54 for rotation relatively to the hinging-body 56, which advances the speed of opening/closing the foldable electronic device 50.

In the embodiment, the foldable electronic device 50 further includes a torsion module 180, and the torsion module 180 is located between the above-mentioned position-limiting elements 150 and positioning-element 170 and sheathed on the pair of pivoting-shafts 140. When the first body 52 and the second body 54 rotate relatively to the hinging-body 56, the torsion module 180 can limit the rotations of the first cradle 110 and the second cradle 120 on the pivoting-shafts 140.

Specifically, the torsion module 180 has a pair of fasteners 182 and a pair/multiple pairs of torsion-washers 184. The pair of fasteners 182 and the pair of torsion-washers 184 are sequentially disposed between the positioning-element 170 and the set of gears 160 and respectively allow the pair of pivoting-shafts 140 going through to be tightened through fasteners 182 (for example, screws). In more detail, the pair of pivoting-shafts 140 in the embodiment respectively has a deformed shaft-segment 140a and the partial deformed shaft-segments 140a have external threads. When the deformed shaft-segments 140a go through the fasteners 182, the external threads of the deformed shaft-segments 140a fit the internal threads of the fasteners 182 so that the fasteners 182 are closely joined by the deformed shaft-segments 140a. In addition, the deformed shaft-segments 140a of the pivoting-shafts 140 go through the corresponding primary gears 162 so that the partial deformed shaft-segments 140a (the portions of the deformed shaft-segments 140a without external threads) are inserted into the corresponding primary gears 162 to ensure the pivoting-shafts 140 together with the inserted primary gears 162 rotating.

Moreover, the torsion module 180 further has a pair of rotation fixing-elements 186, the pivoting-shafts 140 using the deformed shaft-segments 140a thereof to go through the corresponding rotation fixing-elements 186 to ensure the rotation fixing-elements 186 together with the pivoting-shafts 140 rotating. The pair of rotation fixing-elements 186 respectively have one or multiple positioning-notches 186a. In the embodiment, the rotation fixing-elements 186 respectively have six positioning-notches 186a shown in FIG. 3. The position-limiting elements 150 connected to the rotation fixing-elements 186 have also six corresponding positioning-protrusions 152. The positioning-protrusions 152 are locked at the positioning-notches 186a to make the torsion module 180 allow the pair of pivoting-shafts 140 rotating by different predetermined angles. In this way, the first body 52 of the foldable electronic device 50 can rotate relatively to the second body 54 to the desired angle orientation. In addition, the pair of position-limiting elements 150 respectively have two position-limiting shaft-holes 154. When the deformed shaft-segments 140a go through the pair of position-limiting elements 150, the partial deformed shaft-segments 140a of the pivoting-shafts 140 (the portions of the deformed shaft-segments 140a without external threads) can rotate in the corresponding position-limiting shaft-holes 154. With the above-mentioned design of the positioning-element 170, when the foldable electronic device 50 turns over, the torsion module 180, through the holding of the positioning-element 170, prevents the components (the fasteners 182, the torsion-washers 184 and the rotation fixing-elements 186) in the torsion module 180 from moving with the rotation and avoids the misalignments of the holes of the above-mentioned components.

In the embodiment, the foldable electronic device 50 further includes a pair of fastening washers 190, and the positioning-element 170 has a pair of positioning shaft-holes 174. The pair of positioning shaft-holes 174 respectively allows the pair of pivoting-shafts 140 going through and the pair of fastening washers 190 respectively tightened to the pivoting-shafts 140. As a result, the above-mentioned position-limiting elements 150, set of gears 160 and torsion module 180 are fixed at the pivoting-shafts 140. In more details, the pair of pivoting-shafts 140 respectively has a fastening shaft-segment 140b and a rotating shaft-segment 140c. When the fastening shaft-segments 140b go through the fastening washers 190, the external threads of the fastening shaft-segments 140b fit the internal threads of the fastening washers 190, so that the fastening washers 190 are closely joined by the fastening shaft-segments 140b. In addition, the pivoting-shafts 140 further use the rotating shaft-segments 140c thereof to go through the corresponding positioning shaft-holes 174 to ensure the pivoting-shafts 140 rotating in the corresponding positioning shaft-holes 174.

In summary, the positioning-element of the invention is structurally independent from the pair of position-limiting elements, i.e., the positioning element and the position-limiting elements are not integrally formed. In comparison with the prior art where the positioning element and the position-limiting elements are integrally formed, the invention does not need, as the conventional layout, to cross the set of gears. As a result, the overall thickness of the hinge mechanism is reduced. Therefore, in the invention, the positioning element and the position-limiting elements are individually disposed at the hinge mechanism so as to reduce the overall thickness of the hinge mechanism, and the thickness of the hinge mechanism of the foldable electronic device is reduced as well.

Moreover, with the above-mentioned design of the positioning-element, when the foldable electronic device turns over, the torsion module between the positioning-element and the position-limiting elements, through the holding of the positioning-element, prevents the components in the torsion module from moving with the rotation and avoids the misalignments of the holes of the above-mentioned components. In addition, the positioning-element can avoid the torsion module from moving caused by the torsion action on the torsion module when the foldable electronic device turns over, which further makes the hinge mechanism fixed without suffering the interference by the rotation.

It will be apparent to those skilled in the art that the descriptions above are several preferred embodiments of the invention only, which does not limit the implementing range of the invention. Various modifications and variations can be made to the structure of the invention without departing from the scope or spirit of the invention. The claim scope of the invention is defined by the claims hereinafter.

What is claimed is:

1. A hinge mechanism, suitable for a foldable electronic device, wherein the foldable electronic device has a first body, a second body and a hinging-body; the hinge mechanism comprising:
a first cradle, configured to be fixed to the first body;
a second cradle, configured to be fixed to the second body;
a pair of pivoting-shafts, respectively fixed to the first cradle and the second cradle;
a pair of position-limiting elements;
a set of gears, having a pair of primary gears and a pair of secondary gears, wherein the pair of primary gears is located between the pair of position-limiting elements, the pair of pivoting-shafts goes through the pair of position-limiting elements and respectively goes through the pair of primary gears to make the pair of primary gears pivoted between the pair of position-limiting elements, the pair of secondary gears is located between the pair of position-limiting elements and pivoted to the pair of position-limiting elements, the pair of primary gears is respectively engaged with the pair of secondary gears, and the pair of secondary gears is engaged with each other; and
a positioning-element, configured to be fixed to the hinging-body and structurally independent from the pair of position-limiting elements, wherein the positioning-element is pivoted to the pair of pivoting-shafts so as to be detachably assembled with the pair of position-limiting elements, the first body rotates relatively to the hinging-body through the first cradle rotates the pivoting-shaft fixed to the first cradle relatively to the positioning element so as to bring both the pair of primary gears and the pair of secondary gears for rotation, to make the second cradle rotate the pivoting-shaft fixed to the second cradle relatively to the positioning-element and to bring the second body for rotation relatively to the hinging-body.

2. The hinge mechanism as claimed in claim 1, further comprising:
a pair of fastening washers, wherein the positioning-element has a pair of positioning shaft-holes, the pair of positioning shaft-holes allows the pair of pivoting-shafts respectively going through and allows the fastening washers respectively fastened to the pair of pivoting-shafts.

3. The hinge mechanism as claimed in claim 2, wherein each of the pair of pivoting-shafts has a fastening shaft-segment and a rotating shaft-segment; when the fastening shaft-segments go through the fastening washers, external threads of the fastening shaft-segments are fitted with internal threads of the fastening washers; when the pivoting-shafts go through the positioning shaft-holes, the rotating shaft-segments respectively rotate in the positioning shaft-holes.

4. The hinge mechanism as claimed in claim 1, further comprising:
a torsion module, sheathed on the pair of pivoting-shafts, and when the first body and the second body rotate relatively to the hinging-body, the torsion module is able to limit the rotations of the first cradle and the second cradle on the pair of pivoting-shafts.

5. The hinge mechanism as claimed in claim 4, wherein the torsion module has a pair of fasteners, the pair of fasteners allows the pair of pivoting-shafts respectively going through and fastening, each of the pair of pivoting-shafts has a deformed shaft-segment and parts of the deformed shaft-segments have external threads, when the deformed shaft-segments go through the fasteners, the external threads of the deformed shaft-segments are fitted with the internal threads of the fasteners.

6. The hinge mechanism as claimed in claim 4, wherein the torsion module has a pair of torsion-washers, and the pair of torsion-washers is disposed between the positioning-element and the set of gears and respectively allows the pair of pivoting-shafts going through.

7. The hinge mechanism as claimed in claim 1, wherein each of the pair of pivoting-shafts has a deformed shaft-segments, when the pair of pivoting-shafts respectively goes through the pair of the primary gears, a part of the deformed shaft-segment is respectively inserted into the primary gears so that each of the pair of pivoting-shafts together with the inserted primary gear rotate.

8. The hinge mechanism as claimed in claim 1, wherein each of the pair of pivoting-shafts has a deformed shaft-segments, each of the position-limiting elements has two position-limiting shaft-holes, when the deformed shaft-segments go through the pair of the position-limiting elements, the partial deformed shaft-segments of the pivoting-shafts are able to rotate in the position-limiting shaft-holes.

9. A foldable electronic device, comprising:
a first body;
a second body;
a hinging-body; and
a hinge mechanism, comprising:
a first cradle, fixed to the first body;
a second cradle, fixed to the second body;
a pair of pivoting-shafts, respectively fixed to the first cradle and the second cradle;
a pair of position-limiting elements;
a set of gears, having a pair of primary gears and a pair of secondary gears, wherein the pair of primary gears is located between the pair of position-limiting elements, the pair of pivoting-shafts goes through the pair of position-limiting elements and respectively goes through the pair of primary gears to make the pair of primary gears pivoted between the pair of position-limiting elements, the pair of secondary gears is located between the pair of position-limiting elements and pivoted to the pair of position-limiting elements, the pair of primary gears is respectively engaged with the pair of secondary gears, and the pair of secondary gears is engaged with each other; and
a positioning-element, fixed to the hinging-body and structurally independent from the pair of position-limiting elements, wherein the positioning-element is pivoted to the pair of pivoting-shafts so as to be detachably assembled with the pair of position-limiting elements, the first body rotates relatively to the hinging-body through the first cradle rotates the pivoting-shaft fixed to the first cradle rotate relatively to the positioning element so as to bring both the pair of primary gears and the pair of secondary gears for rotation, to make the second cradle rotate the pivoting-shaft fixed to the second cradle relatively to the positioning-element and to bring the second body for rotation relatively to the hinging-body.

10. The foldable electronic device as claimed in claim 9, further comprising:
a pair of fastening washers, wherein the positioning-element has a pair of positioning shaft-holes, the pair of positioning shaft-holes allows the pair of pivoting-shafts respectively going through and allow the fastening washers respectively fastened to the pair of pivoting-shafts.

11. The foldable electronic device as claimed in claim 10, wherein each of the pair of pivoting-shafts has a fastening shaft-segment and a rotating shaft-segment; when the fastening shaft-segments go through the fastening washers, external threads of the fastening shaft-segments are fitted with internal threads of the fastening washers; when the pivoting-shafts go through the positioning shaft-holes, the rotating shaft-segments respectively rotate in the positioning shaft-holes.

12. The foldable electronic device as claimed in claim 9, further comprising:
a torsion module, sheathed on the pair of pivoting-shafts, and when the first body and the second body rotate relatively to the hinging-body, the torsion module is able to limit the rotations of the first cradle and the second cradle on the pair of pivoting-shafts.

13. The foldable electronic device as claimed in claim 12, wherein the torsion module has a pair of fasteners, the pair of fasteners allows the pair of pivoting-shafts respectively going through and fastening, each of the pair of pivoting-shafts has a deformed shaft-segment and parts of the deformed shaft-segments have external threads, when the deformed shaft-segments go through the fasteners, the external threads of the deformed shaft-segments are fitted with the internal threads of the fasteners.

14. The foldable electronic device as claimed in claim 12, wherein the torsion module has a pair of torsion-washers, and the pair of torsion-washers is disposed between the positioning-element and the set of gears and respectively allows the pair of pivoting-shafts going through.

15. The foldable electronic device as claimed in claim 9, wherein each of the pair of pivoting-shafts has a deformed shaft-segments, when the pair of pivoting-shafts respectively goes through the pair of the primary gears, a part of the deformed shaft-segment of the pivoting-shafts is respectively inserted into the primary gears so that each of the pair of pivoting-shafts together with the inserted primary gear rotate.

16. The foldable electronic device as claimed in claim 9, wherein each of the pair of pivoting-shafts has a deformed shaft-segments, each of the position-limiting elements has two position-limiting shaft-holes, when the deformed shaft-segments go through the pair of the position-limiting elements, the partial deformed shaft-segments of the pivoting-shafts are able to rotate in the position-limiting shaft-holes.

17. The foldable electronic device as claimed in claim 9, wherein the first body comprises a display screen and the second body comprises a keyboard.
